(19) United States
(12) Patent Application Publication
(10) Pub. No.: US 2011/0079684 A1
(43) Pub. Date: Apr. 7, 2011

(54) Centrifugal Engine and Vehicle Featuring Same

(76) Inventor: Boguslaw Rudzik, Calgary (CA)

(21) Appl. No.: 12/574,238

(22) Filed: Oct. 6, 2009

(51) Int. Cl. B64G 1/28; H02K 21/14; F03G 3/00

(52) U.S. Cl. 244/73 R; 310/156.01; 74/84 R

(57) ABSTRACT

A centrifugal engine features a round enclosure centered on an axis and having an outer wall closing the interior around the axis between a base and a cover. An inner surface of the outer wall slopes outwardly away from the axis where the outer wall extends away from the base toward the cover. A liquid is contained within the sealed interior space. A drive system carried with the enclosure is operable to effect rotation of the round enclosure about the axis at sufficient speed to force the liquid outwardly away from the axis against the sloping inner surface of the outer wall and thereby exert pressure against the cover. This force of this pressure displaces the enclosure and the drive system carried therewith in a direction along the axis. Vehicle can employ multiple engines of this type along perpendicular axes to produce movement in different directions.

### FIELD OF THE INVENTION

The subject of this invention is a centrifugal engine (CE) and vehicles that use this CE to move in any fluid or space.

### BACKGROUND OF THE INVENTION

In present aviation or space industries combustion engines have been used as a source of thrust for example by airplanes, jets and rockets. In these vehicles long distance travel is dependent on huge amounts of fuel that need to be stored and attached to the vehicle drastically increasing the vehicle's total load. This method of take off is inefficient; by requiring more fuel at launch the vehicle has to accommodate a larger weight, (the massive weight of the fuel) and therefore must provide a larger thrust. Such an engine makes very long distance travel almost impossible. More fuel equals more load, and this is a vicious cycle.

Accordingly, there is a desire to develop new devices for producing thrust and new vehicles employing these devices.

### SUMMARY OF THE INVENTION

According to a first aspect of the invention there is provided a centrifugal engine comprising:

a round enclosure centered on an axis and defining a sealed interior space within the enclosure, the enclosure comprising an outer wall that closes the interior space around the axis between a base and a cover, an inner surface of the outer wall facing inward toward the axis being nonparallel therewith and sloping outwardly away from the axis where the outer wall extends away from the base toward the cover;

a liquid contained within the sealed interior space; and

a drive system carried with the enclosure and operable to effect rotation of the enclosure about the axis at sufficient speed to force the liquid outwardly away from the axis against the sloping inner surface of the outer wall and exert pressure against the cover under tendency of the liquid to move theretoward along the sloping inner surface of the outer wall to displace the enclosure and the drive system carried therewith in a direction along the axis corresponding to the pressure against the cover.

Preferably the enclosure is of a ring structure closing around the axis to enclose an endless channel around the axis between the cover and the base and between the outer wall and an opposing inner wall.

Preferably the endless channel enclosed by the enclosure and containing the liquid has a rhombus-shaped cross-section.

Preferably the inner surface of the outer wall slopes between the base and the cover at forty-five degrees relative to the axis in a cross-sectional plane radial thereto.

Preferably there is provided an outer housing in which the ring structure is disposed for rotation about the axis, wherein the drive system comprises electrically conductive coils disposed within the housing with the ring structure passing through the coils and the coils overlapping one another around the axis.

Preferably the ring structure comprises magnetically attractable sections alternating around the axis with less magnetically attractable sections, the overlapping coils being equal in number to a total number of the magnetically attractable and less magnetically attractable sections and being arranged to energize a first set of alternating coils around the axis to magnetically draw the magnetically attractable sections toward positions centered along paths through the first set of alternating coils, de-energize the first set of alternating coils before the magnetically attractable sections pass said positions and then energize a second set of alternating coils to drive rotation of the ring structure about the axis in a predetermined direction.

Preferably the endless channel of the ring structure is divided into independent segments positioned end-to-end around the axis and each filled with the liquid, each independent segment of the endless channel corresponding to a respective one of the magnetically attractable and less magnetically attractable segments and the liquid comprising a non compressible heavy liquid, preferably mercury. In this case, the endless channel is assembled from alternating segments with magnetic and non-magnetic properties and each of them has the same liquid inside.

Alternatively, alternating sections around the axis may contain opposite ones of a magnetically attractable liquid and a less magnetically attractable liquid, the overlapping coils being equal in number to a total number of the sections and being arranged to energize a first set of coils alternating around the axis to magnetically draw the sections containing the magnetically attractable liquid toward positions centered along paths through the first set of coils and de-energize before the same sections pass said positions to drive rotation of the ring structure about the axis in a predetermined direction.

Preferably the ring structure rotates within the housing along interfaces between outer surfaces of the ring structure and inner surfaces of the outer housing, the coil closing about the ring outward from the sliding interfaces.

Preferably the interfaces comprise sliding interfaces where the outer surfaces of the ring structure slide over the inner surfaces of the outer housing.

Preferably there is provided friction reducing material at the sliding interfaces.

Preferably the friction reducing material comprises Teflon.

Preferably the liquid comprises non-compressible heavy liquid.

Preferably the liquid is mercury.

According to a second aspect of the invention there is provided a vehicle comprising:

a frame;

a centrifugal engine set comprising at least one centrifugal engine unit carried on the frame, each centrifugal engine unit comprising at least one centrifugal engine and each centrifugal engine comprising:
a round enclosure centered on a respective axis and defining a sealed interior space within the enclosure, the enclosure comprising an outer wall that closes the interior space around the axis between a base and a cover, an inner surface of the outer wall facing inward toward the axis being nonparallel therewith and sloping outwardly away from the axis where the outer wall extends away from the base toward the cover;
a liquid contained within the sealed interior space; and
a drive arrangement carried on the frame with the enclosure and operable to effect rotation of the enclosure about the axis at sufficient speed to force the liquid outwardly away from the axis against the sloping inner surface of the outer wall and exert pressure against the cover under tendency of the liquid to move theretoward along the sloping inner surface of the outer wall to displace the enclosure, the drive system and the frame in a direction along the axis corresponding to the pressure against the cover.

Preferably each centrifugal engine unit comprises a pair of engines, each pair of engines comprising two engines lying on a common axis, facing a common direction therealong to exert the pressure of the fluids in the common direction and rotating the fluids in the two engines in opposite directions about the common axis to counteract tendencies of one another to spin the frame about the common axis.

Preferably the centrifugal engine unit set comprises two centrifugal engine units having the common axes thereof oriented perpendicular to one another to effect displacement in perpendicular directions along a plane in which the axes lie.

Preferably the centrifugal engine unit set comprises three centrifugal engine units having their axes oriented perpendicular to one another to facilitate motion of the vehicle in three dimensions.

Preferably the centrifugal engine unit set comprises at least one opposing pair of centrifugal engine units, each opposing pair of centrifugal engine units comprising two centrifugal engine units lying on coincident axes and facing opposite directions therealong each to effect displacement of the vehicle in the opposite directions along the coincident axes under separate operation of the two centrifugal engines.

The enclosure of each engine may be a ring structure and the axes of the three centrifugal engine units intersect at a common central point of the vehicle, the ring structure of an outer engine unit of the three centrifugal engine units closing around the ring structures of two center engine units of the three centrifugal engine units and the ring structure of one of the two center engine units closing about the other. In this case, the outer engine unit may close around additional centrifugal engine units spaced apart about the axis of the outer engine unit in orientations parallel thereto for use as stabilizers, for example use in turbulent atmosphere.

Alternatively, the centrifugal engine unit set may comprise a plurality of centrifugal engine units disposed at spaced apart positions along one of the axes thereof, the one of the axes also defining an axis of an elongated structure of the frame on which the plurality of centrifugal engine units are carried. In this case, preferably the plurality of centrifugal engines comprises, at each end of the elongated structure, three CEU pairs perpendicular to one another, one pair for each axis (x, y, z) to provide movement in +−X, +−Y and +−Z directions. Between these six outermost CEU pairs are numerous CEUs oriented along the main + or −Z direction. The plurality of centrifugal engine units are preferably disposed in a cigar shaped enclosure having a cigar axis.

### BRIEF DESCRIPTION OF THE DRAWINGS

In the accompanying drawings, which illustrate exemplary embodiments of the present invention:

FIG. 1 is a schematic illustration of the principles of operation of a centrifugal engine of the present invention.

FIG. 2 is a partial overhead plan view of the centrifugal engine of the present invention.

FIG. 3 is a schematic cross-sectional view of the centrifugal engine as taken along line A-A of FIG. 2.

FIG. 4 is a schematic cross-sectional view of the centrifugal engine as taken along line B-B of FIG. 2.

FIG. 5A is a schematic illustration of the principles of rotation of the centrifugal engine of the present invention in terms of a first embodiment drive system for same.

FIG. 5B is a schematic illustration of the principles of rotation of the centrifugal engine of the present invention in terms of a second embodiment drive system for same.

FIG. 6 is an overhead plan view of a vehicle employing centrifugal engines of the present invention.

FIG. 7 is cross-sectional view of the vehicle of FIG. 5 as taken along line A-A thereof.

FIG. 8 is an overhead plan view of a more simplified vehicle employing centrifugal engines of the present invention.

FIG. 9 is cross-sectional view of the vehicle of FIG. 7 as taken along line A-A thereof.

FIG. 10 is an overhead plan view of another vehicle employing centrifugal engines of the present invention.

FIG. 11 is a side elevational view of the vehicle of FIG. 10.

FIG. 12 is a schematic illustration of engine layout in a higher-acceleration vehicle employing centrifugal engines of the present invention.

FIG. 13 is a schematic illustration of the vehicle of FIG. 12.

### DETAILED DESCRIPTION

Known engines for aviation are combustion engines such as the piston engine, the turbo-jet engine, the aero-pulse engine and the rocket engine. All of them depend on combustion.

The present invention relates to a centrifugal engine (CE) that uses centrifugal forces to overcome gravity and lift the engine, and ultimately the vehicle on which it is used, or alternatively effect horizontal displacement when oriented differently. The engine of the illustrated embodiment uses a ring-shaped sealed enclosure R enclosing a channel that extends around a central axis A of the engine and has a rhombus cross-section in radial planes through the axis to rotate a non compressible heavy liquid (NCHL) 12 contained therein. The endless channel inside this ring is preferably divided into independent segments, which would act to minimize the “waterhammer” phenomenon that would appear when liquid changes its speed. Independent segments also provide improved speed control as the response of the confined or coffined-in segments of liquid would be faster—not depending entirely on friction between liquid and the endless channel walls. The preferred liquid is mercury; because of its density, mercury would create the largest centrifugal force from any other known liquid forms. In the preferred embodiment, the liquid completely fills the segments of the channel to maximize the weight of the liquid, and thus the resulting centrifugal force, and to further minimize any “waterhammer” phenomenon. As the heavy liquid rotates it creates a centrifugal force that then creates pressure on the walls of this ring channel. Due to the channel's rhombus section—specifically the inclination of its outer wall 11 into an orientation obliquely sloping the outer wall's inner surface outwardly away from the axis moving from a bottom base wall of the ring to an opposing top cover wall 10—this centrifugal force creates an unbalanced pressure on the channel's top wall.

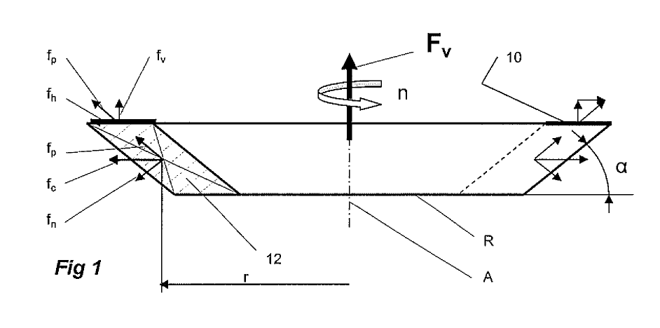

The principals of this phenomenon are illustrated in FIG. 1, in which f_{c} is a unitary centrifugal force (Newtons (N)), fₚ is a unitary force parallel to channel's outer wall (N), fₙ is a unitary force normal to channel's outer wall (N), Fᵥ is a force perpendicular to channel's top wall (“lift” force) (N), r is a unitary mass centre of gravity radius (m), n is rotations (1/sec), α is a angle of outer wall's incline (45° dgr), m is a liquid mass (kg) and v is a speed of rotating liquid (m/sec). The speed of rotating liquid can be expressed as v=2πrn, the unitary centrifugal force as f_{c}=(mv̂2)/(r2Πr), the parallel component of unitary centrifugal force as fₚ=f_{c}cos α, the perpendicular component of unitary centrifugal force as fₙ=f_{c}sin α, and the lift force as Fᵥ=Σfᵥ=Σfₚsin α=2πr fₚsin α. The terms top, bottom and lift are used with reference to the horizontal orientation of the engine shown in FIG. 1, where the ring closes around a vertical axis in a horizontal plane and the pressure against the top wall or cover of the ring enclosure exerts force vertically upward to lift the ring. It will be appreciated from the following description however that the engine may be used in other orientations to effect displacement of the engine in other directions, as will be demonstrated by description of vehicles employing this engine further herein below.

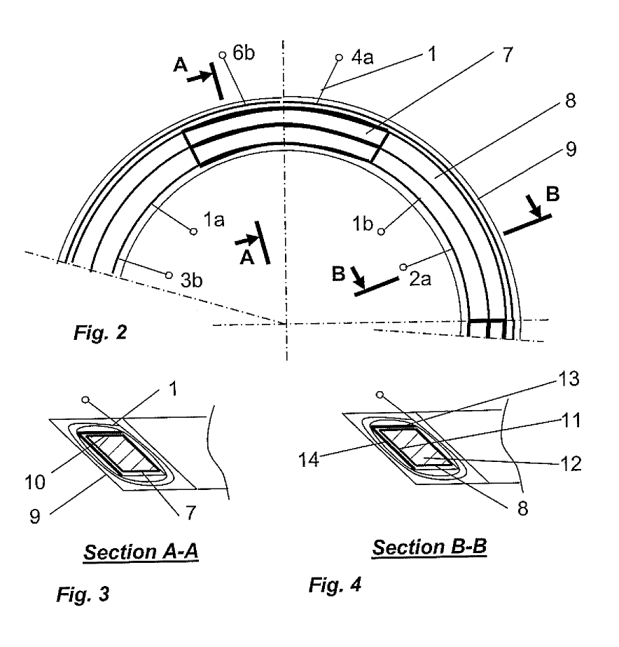

In the centrifugal engine, the driving force or “lift” is generated by one of the centrifugal force components created by rotating a 45 degree rhombus shaped ring channel containing a NCHL. The rotation of the ring channel and NCHL contained therein can be controlled by using electricity. In one embodiment the ring channel is divided into segments that alternate between magnetic and non-magnetic properties. This can be achieved by taking an endless ring structure made of non-magnetically attractable material and then fixing pieces of magnetically attractable material to its exterior at spaced positions around the ring. Electromagnetic coils that create electromagnetic fields would interact with the magnetic segments to produce rotation. Supplying electricity is more feasible than supplying combustible fuel, for example by using photocells, batteries or by using radioisotope power source similar or better than was use on the board of spacecrafts PIONIER 10 and 11. With reference to FIGS. 2 to 5, the ring enclosure is made up of magnetically-attractable and non-magnetically-attractable sections alternating around the central axis of the engine. The magnetically-attractable sections 7 have their external surfaces outside the internal channel covered with ferromagnetic material so as to be attractable to a magnetic source when situated proximate thereto, while the non-magnetically-attractable sections 8 are of the ring's original non-ferromagnetic material that is not responsive to exposure to magnetic fields. A ring-shaped outer housing 9 closing about the axis contains the ring channel enclosure inside it.

With reference to FIGS. 3 and 4, the outer housing is similar in shape to the inner ring enclosure, but larger in size to fit the inner ring enclosure inside the interior space of the housing, which is also rhombus-shaped in cross section. The corresponding walls of the two rings are parallel to create a sliding interface between them as the inner ring rotates within the outer ring-shaped housing, this sliding interface being particularly important between the top wall 10 of the inner ring channel and the inner surface 13 of the housing's cover, where the inner ring will push against the housing cover under operation of the engine, and between the outer wall 11 of the inner ring and the inner surface 14 of the housing's outer wall where the weight of the inner ring will be taken by the housing in a vertically oriented engine in which the inner ring rotates about a horizontal axis. Friction reducing material or lubricant is provided between the outer surfaces of the inner ring's walls and the inner surfaces of the outer housing's walls to reduce friction and wear. This may be accomplished by a Teflon coating on the walls or on plates mounted thereon. Other means for lowering friction in the relative movement between the inner ring enclosure and the outer housing are also possible, such as roller element bearings or magnetic levitation.

With reference to FIGS. 2 to 5A, six electrically conductive coils 1, 2, 3, 4, 5, 6 are embedded inside the wall material of the outer housing to wind around the circular rotational path followed by the ring enclosure inside the outer housing at a position. Terminals, (schematically shown at 1a, 1b, 2a, 2b, 3a, 3b, 4a, 4b, 5a, 5b, 6a, 6b) at opposite ends of each coil are arranged for selective conductive connection to an electrical power source. Accordingly, the ring moves along an arcuate path through each coil when the ring is rotated inside the stationary outer housing 9. The ring is divided into six equal segments, three of which are magnetically attractable and three of which are not. With one of the magnetic sections of the inner ring enclosure sufficiently close in angular position around the axis to the center of a respective coil, a magnetic field provided by energizing the coil acts to pull the magnetic section of the inner ring into a central position along the path through the coil, but that coil is de-energized before that segment reaches this central position in the ring and the next coil around the axis is energized to draw the same segment toward its center, forcing the rotational motion of the ring to continue onward in the same direction. Rotation of the inner ring enclosure can accordingly be driven by controlling energization and de-energization of the coils. In a starting position with a magnetic section of the inner ring enclosure near or partially within the coil, but not centered along the path therethrough or past a central position along this path in a predetermined direction about the axis, energizing the coil will pull the magnetic section toward the central position on the path through the coil, thereby inducing rotation of the inner ring enclosure about the axis. Before the magnetic section passes the positioned centered along the path through the coil, the coil is de-energized to remove the magnetic attraction of the magnetic section of the inner ring enclosure so as not to resist continued rotation of the ring in the same direction and the next coil around the housing is energized to force the movement of that segment of the ring to continue in the same direction by drawing the same magnetic section toward its center before de-energizing and allowing the magnetic segment to pass by its center.

This energizing and de-energizing sequence of all six coils forcing the movement of the mercury filled ring is then repeated as the next magnetic section approaches or enters the first coil under the rotation of the ring in the predetermined direction. The winding of each of the six coils of the illustrated embodiment spans about ninety degrees about the central axis, and the centers of these angular spans of the coils are equally spaced about the axis, so that the adjacent coils overlap one another around the axis to smooth the motion of the inner ring. In such a configuration, with inner coils 1, 2, 3 alternating with and extending partially into outer coils 4, 5, 6 around the axis, the inner coils 1, 2, 3 and energize simultaneously and de-energize simultaneously, and the outer coils 4, 5, 6 energized simultaneously and de-energize simultaneously. During continued driving of the engine, each “on” or activated period of one of these alternating coil sets occurs between two “on” or activated periods of the other coil set. Control over timing of the coil activation, deactivation and energized period therebetween can be effected using mechanical, electrical or computerized systems or combinations thereof to control conductive connection between each coil and the engine's DC power source.

The “working” engine has three distinct stages:
Stage 1) There is no rotation and the NCHL is resting within the inner ring channel. The only force acting on the inner channel's walls is the weight of the NCHL.
Stage 2) When the ring with the NCHL is in rotation at N1 rpm, the rotating NCHL creates a centrifugal force component that is perpendicular to the plane of rotation and is in equilibrium with gravity. At an N1 rpm rotation speed, the engine produces a force that equals or cancels the force of the NCHL gravity.
Stage 3) In this stage, the rotation speed is increased to N2 rpm. Accordingly the resulting centrifugal force is larger, and the rotating NCHL would elevate along the inner ring's inclined outer wall if no cover was present, but, due to the fact that the rhombus ring channel is totally enclosed, the NCHL ring pushes on the top over of the inner channel with an unbalanced force that is equal to the entire weight of the apparatus. Any rotation higher than N2 would create a force enabling lift or movement.

In the CE, acceleration and movement is controlled by regulating the rotation speed of the inner ring which in turn regulates the rotation speed of the liquid. By increasing or decreasing the NCHL's rotation speed the lifting or driving force's magnitude is respectively changed. As previously mentioned, a CE could operate on electricity. As discussed the inner rhombus ring channel could be divided into segments that alternate between two types of construction. Though each segment contains the NCHL, every second segment has a ferromagnetic iron shell used because of its electromagnetic properties, while the in-between segments are made only from a non-magnetic material. Electromagnetic coils that wind around the inner ring channel only interact with the “iron segments” and are used to regulate the inner ring channel's and the NCHL's rotation speed. In the illustrated embodiment, the magnetic and non-magnetic segments of the inner ring channel are each three in number, for a total of six equally sized segments containing the same amount of liquid, and the ring's circular path is divided by six overlapping coils winding around the ring, each coil covering 90 degrees of the inner ring about the axis. Accordingly, in a starting position magnetic segments will be at least partially within the coils then by activation of the coils the coils will pull toward the center of the coils. Before the magnetic segments pass the center of the coils, the coils will be deactivated and the next coils will be energized, forcing the continued movement. This energizing and de-energizing sequence is then repeated as the magnetic segments enter the coils under the rotation of the ring in the predetermined direction. In case when the magnetic segments are resting in the middle of three coils, energizing those three coils would fail to drive any initial movement of inner ring, so the other three coils next to them have to be energized and the movement is forced. Computerized control can be used to monitor for motion of the inner ring after an initial activation of one coil set, and if no such motion is detected, effect activation of the other coil set.

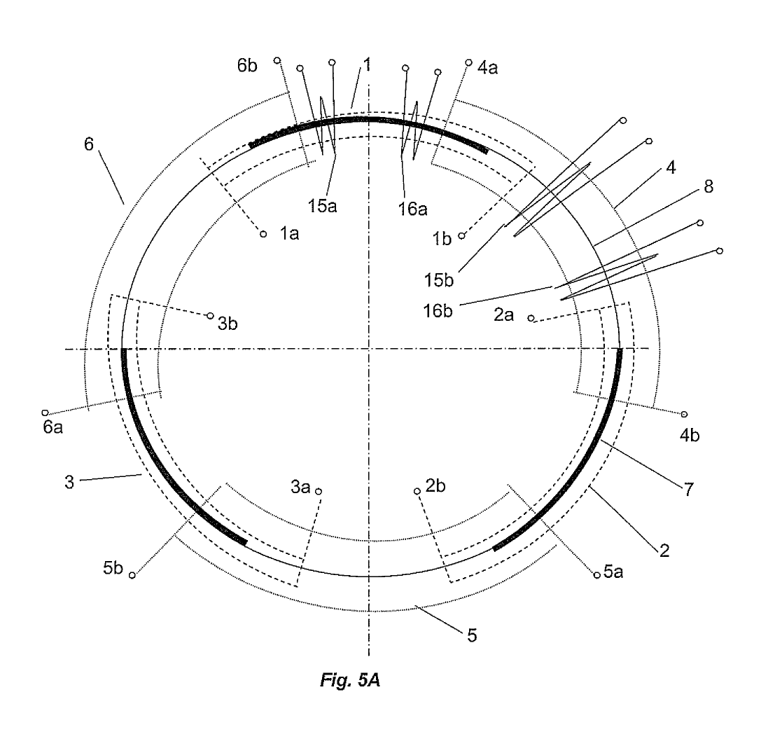

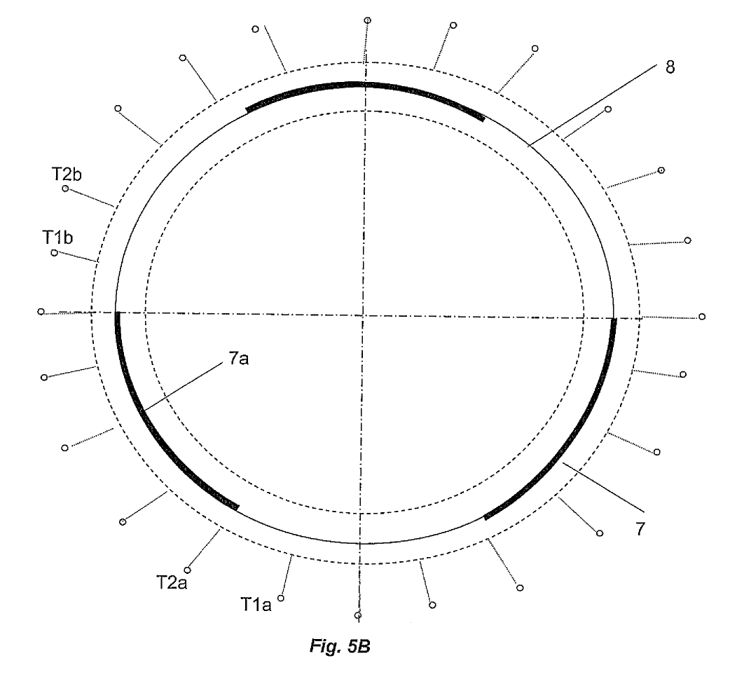

Referring to FIG. 5A, the six overlapping coils will not initialize the movement of the inner ring from a stand-still if the initially stationary ring has its six segments centered within the six overlapping coils, as each magnetic section would not be moved by the coil in which it is centered and would be pulled equally in opposite directions by the two coils containing the segments opposing ends. To overcome this problem and ensure that the ability of the engine to start does not rely on chance (i.e. does not depend on where the inner ring stopped rotating the last time the engine was used), one of the inner coils 1 and one of the outer coils 4 are each provided with a pair of starting coils 15a, 16a, 15b, 16b enclosing around the overlapping coil on opposite sides of the center thereof (i.e. on opposite sides of the midpoint of the coil's span along the rotational path of the inner ring).

Should the magnetic sections 7 of the inner ring end up stopped at the central positions within the inner coils 1, 2, 3 after use of the engine, as shown in FIG. 5A, initial energization of inner coils 1, 2, 3 and subsequent de-energization thereof and activation of outer coils 4, 5, 6 will fail to rotate the inner ring and move the magnetic and non-magnetic sections about the axis in the next attempted use of the engine. So to start the engine, the starting coil 16a wrapped around the inner coil 1 to the side of the center of the inner coil corresponding to the desired direction of rotation (clockwise in FIG. 5A) is activated after the failure of the initial inner and outer coil energization/de-energization sequences to move the inner ring. The magnetic section in the inner coil 1 equipped with the starter coils 15a, 16a is accordingly pulled in that direction toward the next outer coil 4 in this rotational direction. Before the magnetic section becomes centered in the starter coil 16a, the starter coil 16a is de-energized, and the regular alternating energization/de-energization process of the six overlapping coils is then executed, starting with energization of the outer coils 4, 5, 6 to drive further rotation of the inner ring.

Should the magnetic sections 7 of the inner ring instead end up stopped at the central positions within the outer coils 4, 5, 6 after use, initial separate energization and de-engergization of the inner and outer coil sets will again fail to rotate the inner ring and move the magnetic and non-magnetic sections about the axis. To start the engine, the starting coil 16b wrapped around the outer coil 4 to the side of the center of the outer coil corresponding to the desired direction of rotation (clockwise in FIG. 5A) is activated after the failure of the initial inner and outer coil energization/de-energization sequences to move the inner ring. The magnetic section in the outer coil 4 equipped with the starter coils 15b, 16b is accordingly pulled in that direction toward the next inner coil 2 in this rotational direction. Before the magnetic section becomes centered in the starter coil 16b, the starter coil 16b is de-energized, and the regular alternating energization/de-energization process of the six overlapping coils is then executed, starting with energization of the inner coils 1, 2, 3 to drive further rotation of the inner ring.

It will be appreciated that for an engine having a predetermined direction of rotation, the starter coils need not be provided in pairs inside the two coils from the opposite overlapping coil sets. That is, for clockwise rotation in FIG. 5A, only starter coils 16a and 16b are required. However, producing all engines with two starting coils at each of the two overlapping coils selected to provide this starting function allows the same engine structure to be used in all situations regardless of any particular direction of rotation required, as the direction of rotation can be determined during set up by selecting which of the two starter coils to connect the electronic controls to. It will also be appreciated that the starter coils of the sets of alternating coils need not be positioned within adjacent coils around the axis as illustrated in FIG. 5A.

Again, computerized control can be used to control the sequence of coil activations in the engine starting process. By using a sensor arrangement to monitor for movement of the inner ring, the process would be as follows: (i) energize then de-energize either the inner coil set or the outer coil set and monitor for movement of the inner ring; (ii) if no movement was detected, energize and then de-energize the other of the inner and outer coil sets and monitor for movement of the inner ring; (iii) if no movement was detected, energize and then de-energize the starter coil of either the inner or the outer coil set and monitor for movement of the inner ring; (iv) if no movement was detected, energize and then de-energize the starter coil of the other of the inner and outer coil sets; and (v) start the normal coil alternating energization/de-energization sequence of the inner and outer coil sets starting with the coil set opposite that which last had its overlapping coil or starting coil energized and de-energized. If movement is detected in any of steps (i) to (iii), then the process can skip directly to step (v).

FIG. 5B schematically illustrates an alternative coil-based drive system for providing an initializing sequence that will ensure starting of the engine regardless of the initial stationary angular positions of the magnetic segments of the inner ring around the axis. Three endless coils are wound around the endless interior channel of the housing so as to close their windings around the inner ring. Each endless coil is conductively tapped to define twenty-four equally sized coil sections around the rotational axis of the inner ring. Accordingly, twenty-four terminals are individually wired to the coil at positions around the axis marking the ends the coil sections. Six adjacent sections of the endless coil span a collective length (or collective angular distance of ninety degrees) around the axis equal to one of the inner or outer coil coils of the FIG. 5A embodiment, and each of the three endless coils closing around the inner ring's rotational axis has its taps aligned about the axis with the taps of the other two endless coils. Accordingly, the same effect as activating the three non-adjacent coils of the inner coil set or the outer coil set of the FIG. 5A embodiment can be achieved by connecting a voltage across six adjacent sections of each endless coil in a manner that spaces apart each endless coil's active sections two sections around the axis from the active sections of the other two endless coils. To then achieve the same effect as activating the three non-adjacent coils of the opposite coil set of the FIG. 5A embodiment, the electrical connection to each of the endless coils is shifted around the axis by four sections so that each endless coil's active sections are again spaced two sections around the axis from the active sections of the other two endless coils, and the positions of the now-active sections of three endless coils are each offset by sixty degrees (four sections) from the positions of those previously activated and each overlap two of the previously activated positions by thirty degrees (two sections) each.

The FIG. 5B embodiment can therefore use sensors to monitor the position at which the inner ring ceases movement after operation of the engine and subsequently use this information to reflect a starting position of the inner ring the next time the engine is to be driven and accordingly select the appropriate pair of terminals on each endless coil that are spaced apart by six sections thereof and should be conductively connected to the power source to initialize movement of a magnetic segment of the inner ring in order to start the rotational driving of the ring. That is, using sensors to determine or approximate the position of a center of one of the magnetic segments about the axis once the inner ring has stopped rotating, a programmed control system can then select which pair of terminals spaced six sections apart on one of the endless coils should be energized to produce a resultant six-section energized portion of the coil that wraps around at least part of the located magnetic ring segment and leads this segment in the predetermined direction of rotation about the axis. Which of the terminal pairs to simultaneously apply the voltage across in the other endless coils follows from this first determination of where to activate the first endless ring, and activation of these three portions of the three endless coils pulls the three magnetic segments of the inner ring in the predetermined direction about the axis. Before the magnetic segments pass the center of the three activated coil portions, these portions are de-energized. The positions that are offset from and overlap with these just de-energized positions around the axis are then energized to continue to force the ring rotation in the same direction. The alternating energization and de-energization of these positions around the coil are then repeated just as the alternating inner and outer coil energizations of the FIG. 5A embodiment until the engine is to be stopped.

Using FIG. 5B as an example, having determined the position of magnetic segment 7a of the inner ring and from this knowing the this segment is substantially centered with the six coil sections between terminals T1a and T1b, the control system is programmed to instead apply voltage across terminals T2a and T2b one section ahead of terminals T1a and T1b in the desired clockwise rotational direction, to produce energized coil portion that will draw the magnetic ring segment further inside it. Terminals on the other two ends rings are simultaneously electrically connected to the power source to likewise produce energized coil portions closing around but leading the other two magnetic ring segments. The three resulting energized coil portions draw the magnetic ring segments in the predetermined direction around the axis to start the ring's rotation. The conducting terminals on each ring are then switched to de-energize those portions and energize portions offset therefrom and overlapping therewith to continue the rotational drive of the inner ring. The illustrated indexing of the terminal pairs to be connected one terminal forward from terminal pairs on which the magnetic segments of the ring are substantially centered in FIG. 5B is only one example, as selection of terminals T2a and T2b to be more than one terminal ahead of T1a and T1b respectively in the predetermined direction may still provide sufficient magnetic pull on the leading end of the magnetic segment projecting past T2a.

While it may be possible that the endless coil terminals may be mechanically switched on and off to establish and break electrical connection between the coil sections and the power source, electrical controls operable to alter the terminal connections between conductive and non-conductive states may simplify the overall structure of the engine and control system. It will be appreciated that the numbers of coils, magnetic ring segments, terminals and angular sizing of coils, terminals, magnetic ring segments and coil or coil portion overlap may of course be varied while still operating under the same principles and therefore falling under the scope of the present invention.

In another embodiment not shown, the use of magnetic sections of the inner ring may be replaced or augmented by use of a magnetically attractable fluid. That is, the inner ring channel may have its interior space divided into an even number of separate sections about the axis by divider walls disposed in radial planes spaced thereabout. The separate enclosed chambers in the ring would alternate around the axis in containing a ferrofluid attractable to a magnetic source and a non-magnetically-attractable fluid. The rotational drive of such an arrangement would operate the same way as the inner ring of the FIG. 2 embodiment with magnetic and non magnetic segments.

Other alternative embodiments could use other electrically operated drive systems, for example employing an electric motor to rotate the ring or a pump or propeller that would provide the motion of the liquid inside a stationary ring, as other options for how to put the NCHL in motion. For example, a rotational motor could drive rotation of the ring through a drive train ending with a gear defined on the mercury-containing ring to present gear teeth about the axis thereof, or alternatively could have its output shaft lying on the ring axis and coupled to the ring to drive rotation thereof. In the latter case, the lift or driving force can be taken a ring-covering element like the housing of the illustrated embodiment, or using a thrust bearing in the connection between the motor and the ring to accommodate the lift or driving force produced in operation of the engine. It is also possible that such motor driven embodiments may employ more of a covered bowl-type structure for the inner enclosure containing the liquid, thus not have a central hole or opening at the axis, but still presenting a sloped outer wall causing the liquid to climb up the outer wall away from the base or bottom of the bowl toward a an outer perimeter of a planar cover fixed over the bowl-like structure in a plane normal to the rotational axis. However, the preferred embodiment using electromagnetically inductive coils inside a ring shaped engine housing is preferred over external-motor embodiments, as it has the advantages of being a directed-drive system acting to minimizing energy losses that would be significantly greater in external motor embodiments requiring transfer of power from an external motor to the engine ring, and providing a hollow or open center of the engine that allows different diameter engines to be nested one within the other or other equipment to be mounted within the open center of the engine to make efficient use of space. Pumps in line or propellers could alternatively move the liquid around the axis inside a stationary ring but, but this may present problems when using the preferred liquid (mercury), such as issues with corrosion, sealing, and toxicity. Using other liquids of lower specific gravity would demand higher rotational speed in an engine of the same size to achieve the same lift or drive force, as the total mass of liquid would accordingly be lower.

Since the centrifugal force's magnitude is a function of rotation so is the resulting drive force's magnitude, which is perpendicular to the plane of rotation—the higher the rotation speed the larger the “lift”. Two identical CE ring enclosure place placed coaxially one over or adjacent the other and facing the same direction are controlled to rotate at the same rpm but in opposite directions about their common axis to eliminate unwanted vehicle spin thereabout, as a pair provides one-way motion perpendicular to their parallel planes of rotation. This combination of two counter-rotating mercury enclosure rings and their drive sources collectively form a centrifugal engine unit, or CEU. Although the engine of FIGS. 2 to 4 is illustrated with its own dedicated housing defining only a single internal channel for receipt of a single inner ring mercury enclosure, it will be appreciated that a two-ring centrifugal engine unit could employ a single housing structure defining two rotational paths and coil sets about its central axis, one for each of the two counter-rotating rings of the unit.

Using a combination of multiple CEUs, each of which generates its own drive force using a rotating NCHL, enables a vehicle to move freely in any direction of any unobstructed fluid or space. Such vehicles are illustrated in FIGS. 6 to 13. These types of vehicles driven by CEUs can be used for travel to and within different environments, like in underwater and space explorations as well as cruising our or other atmospheres. These vehicles do not need the fuel that presently contributes to most of the launch weight of rockets and other space vehicles. These vehicles weigh practically the same at take-off and landing. They are better suited for long distance travel.

Ultimately the Centrifugal Engine Unit in combination with its electrical power source, such as batteries, photocells, a radioisotope fueled power source or combinations thereof, form an independent and self-contained means of movement and acceleration. When multiple CEUs are strategically combined (see FIGS. 6 and 13) a vehicle with these engines is capable of moving in any direction and in any fluid or space—provided that the vehicle is properly sealed. Such a vehicle is also capable of stopping at any point along its path. For example, a vehicle that is moving above land can stop its movement and suspend itself in the air, and thereafter resume its movement. The vehicle is also able to vertically take off and vertically land. This vehicle is not harmful to the environment since its engine does not produce any pollution.

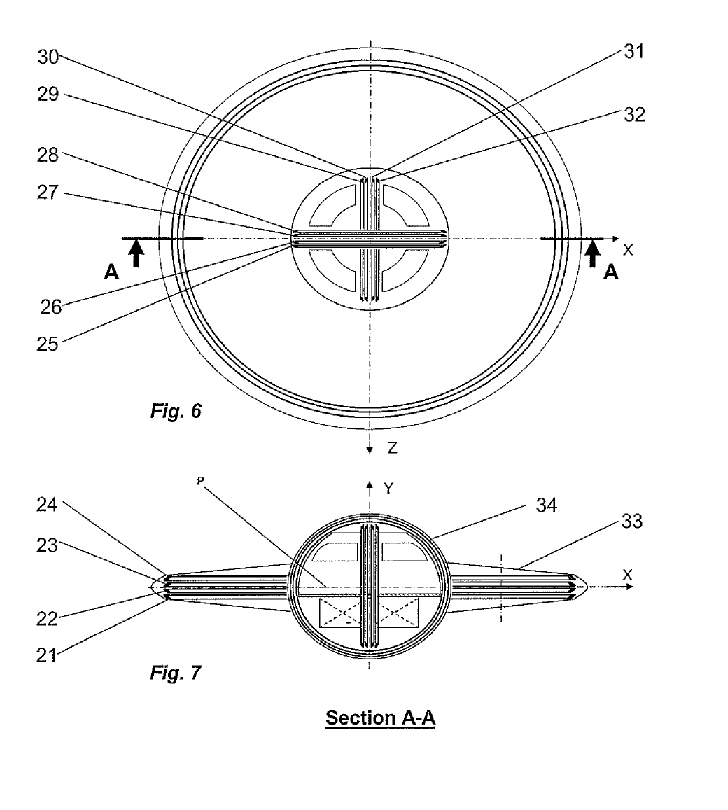

The vehicle shown in FIGS. 6 and 7 has six pairs of CEUs. A CEU pair where the CEUs are placed concentrically side by side and mirrored to face opposite directions will provide movement in both directions along their common axis of rotation. For the vehicle to move in three dimensions, a combination of three CEU pairs should be used: one along the horizontal X axis (FIG. 6: counter-rotating engines 29, 30 opposing counter-rotating engines 31, 32), one along the vertical Y axis (FIG. 7: counter-rotating engines 21,22 opposing counter-rotating engines 23, 24) and one along the horizontal Z axis (FIG. 6: counter-rotating engines 25, 26 opposing counter-rotating engines 27, 28). By changing the NCHL's rotation speed in the CEUs, different resultant drive force vectors on the vehicle can be attained and movement in any direction becomes possible.

In further detail, four identical CEs of a first inner diameter 21, 22, 23, 24 lie concentric with one another in horizontal planes above and below a center horizontal plane containing the intersection point of the X, Y and Z axes. Two of these four first-diameter CEs 23, 24 are disposed one over the other above the center horizontal plane and have their covers facing downward so as to provide a vertically downward driving force when driven in opposite directions at operating speeds, thereby defining a CEU operable to exert driving force in the negative Y direction. The other two of the four first-diameter CEs 21, 22 are disposed one over the other below the center horizontal plane and have their covers facing upward so as to provide a vertically upward driving force, or lifting force, when driven in opposite directions at operating speeds, thereby defining a CEU operable to exert driving force in the positive Y direction.

Four CEs 25, 26, 27, 28 of inner and outer diameters smaller than the four horizontally oriented CE's 21, 22, 23, 24 24 lie concentric with one another in vertical planes on both sides of a first center vertical plane containing the horizontal X axis. Two of these four second-diameter CEs 25,26 are disposed one beside the other on one side of the first center vertical plane and have their covers facing toward this plane so as to provide a horizontal driving force in a negative direction along the Z axis when driven in opposite directions at operating speeds. The other two of the four second-diameter CEs 27, 28 are disposed one beside the other on the opposite side of the first center vertical plane and have their covers facing toward this plane so as to provide a horizontal driving force in a positive direction along the Z axis when driven in opposite directions at operating speeds. The four second diameter CEs 25, 26, 27, 28 thus define a pair of opposing CEUs that provide driving force in opposite directions along the horizontal Z axis when operated.

Four CEs 29, 30, 31, 32 of inner and outer diameters smaller than the second inner diameter lie concentric with one another in vertical planes on both sides of a second center vertical plane containing the horizontal Z axis. Two of these four third-diameter CEs 29, 30 are disposed one beside the other on one side of the second center vertical plane and have their covers facing toward this plane so as to provide a horizontal driving force in a positive direction along the X axis when driven in opposite directions at operating speeds. The other two of the four third-diameter CEs 31, 32 are disposed one beside the other on the opposite side of the second center vertical plane and have their covers facing toward this plane so as to provide a horizontal driving force in a negative direction along the X axis when driven in opposite directions at operating speeds. The four third diameter CEs 29, 30, 31, 32 thus define an opposing pair of CEUs that provide driving force in opposite directions along the horizontal X axis when operated.

The horizontally oriented CEs 21, 22, 23, 24 thus define outer engine units closing around all the other engine units. The second diameter CEs 25, 26, 27, 28 disposed within the open center of the outer engine units likewise close around the third diameter CEs 29, 30, 31, 32, and thus define middle engine units closing around inner engine units. Each pair of engine units (the outer pair of CEUs, the middle pair of CEUs and the inner pair of CEUs) is centered around the intersection point of the X, Y and Z axes. The vehicle's center of mass is located at this central point so that the force exerted by each CEU acts to linearly displace, and not spin, the vehicle. The housings of the CEs are carried on or with a frame of the vehicle, which in turn may defined least in part by the engine housings themselves and interconnections therebetween. A hollow shell 33 of the vehicle encloses the outer CEUs of the vehicle of FIGS. 6 and 6, having a disc-like shape that is round in plan.

To rotate or pivot the vehicle around one of the axes, the rotation speeds of the two counter-rotating CEs in a CEU operable to drive the vehicle along that axis are differentiated. That is by driving rotation of the CE in one direction about the axis at a speed faster than the oppositely rotating CE in the same CEU, the tendency for the faster CE's rotation to spin the vehicle about the axis is not fully counteracted, thus pivoting the vehicle about this axis. Such differential driven rotation of the counter-rotating inner rings of the two CE's a CEU can be used on the CEUs on all axes, so that an operator can pivot the vehicle about any selected one of the X, Y or Z axis. This way the vehicle has the freedom to adjust not only its direction but to also angle or pivot its own plane of reference P (i.e. the horizontal plane containing the X and Z axis in the embodiment of FIGS. 6 and 7).

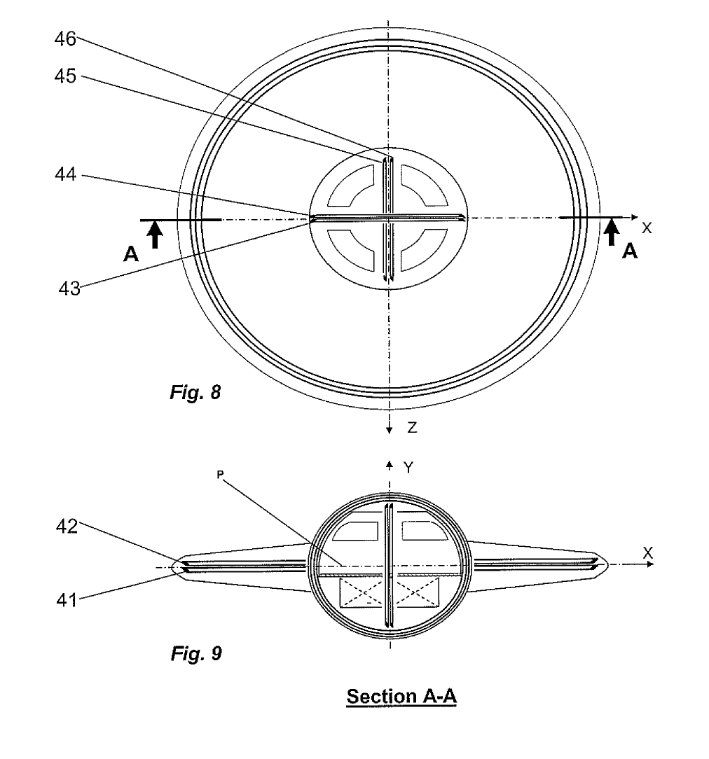

A “Lighter” vehicle that is a simplified but equally sized version of the vehicle describe above and requires less than half the NCHL to provide the same speed and acceleration capabilities can also be built, and is shown in FIGS. 8 and 9. This lighter vehicle has only three CEUs, one on each axis providing movement only in one direction therealong. However, since the vehicle can pivot around its centre by driving rotation of the counter-rotating rings in a CEU at different speeds as described above, it can orient the rings in the desired direction. In the Figures, the counter-rotating CEs 41, 42 closing around the vertical Y axis to define the one outer CEU are oriented horizontally with their covers facing up so as to be operable to drive or lift the vehicle upward in the positive Y direction, the counter-rotating CEs 43, 44 closing around the horizontal Z axis to define the one middle CEU are oriented vertically at the vertical plane containing the X axis with their covers facing forward so as to be operable to drive the vehicle in the positive Z direction, and the counter-rotating CEs 45, 46 closing around the horizontal X axis to define the one inner CEU are oriented vertically at the vertical plane containing the Z axis with their covers facing to one side thereof so as to be operable to drive the vehicle forward in the positive X direction. So, to displace the vehicle in the positive X direction when oriented and positioned as shown in FIG. 8, one just need operate the CEU 45, 46 centered on that axis. However, to displace the vehicle in the negative X direction of a fixed-reference frame from the position and orientation of the vehicle of FIG. 8, on would instead first control the rotational speeds of the CE's 41, 42 of the Y-axis CEU to produce a difference between those speeds and cause the vehicle to rotate about the Y-axis in the direction of the now-slower of the two CE's 41, 42 to reorient the vehicle about the Y-axis so that either of the two vertically oriented CEUs faces the negative X direction of the fixed reference frame. With the Y-axis CEU stopped to maintain this new orientation, the CEU now facing the negative X direction can be operated to displace the vehicle in this direction. That is, for movement in a direction that is in a plane of two of the three CEU axes but is not currently faced by one of CEUs closing around the two axes in that plane, rotation of the vehicle to face a CEU in that direction can be achieved by differential driving of the CEs of the CEU on the axis perpendicular to the plane in which the vehicle is to be rotated. The limitation of this vehicle is that it can not be driven back and forth or up and down without rotating 180 degrees around its centre between such opposing motions.

A further embodiment, not shown in the drawings, could still allow movement in three dimensions while featuring only two CEUs, one horizontally oriented and the other vertically oriented. The horizontally oriented CEU would be operable to control vertical displacement by varying the amount of vertical lift produced, and also operable to control rotation or spin of the vehicle about the vertical axis of this CEU through the above-described use of differential rotational speed between its two individual CEs. Such rotation of the vehicle gives the operator control over which horizontal direction to face the vertically oriented CEU in to drive movement of the vehicle in that direction. After having rotated the vehicle sufficiently toward the desired orientation about its vertical axis, the differential operation of the counter-rotating CEs in the horizontally oriented CEU is stopped. The vertically oriented CEU can be operated alone to horizontally displace the vehicle, or operated together with the horizontally oriented CE to combine the horizontal and vertical drive forces produced by the two CEUs to move in a desirable direction. However, having only two CEUS would make total control over the vehicle more difficult as any instability would change the path of the vehicle, and so the arrangement would not likely allow quick and appropriate response in turbulent conditions unless it is provided with stabilizers 51.

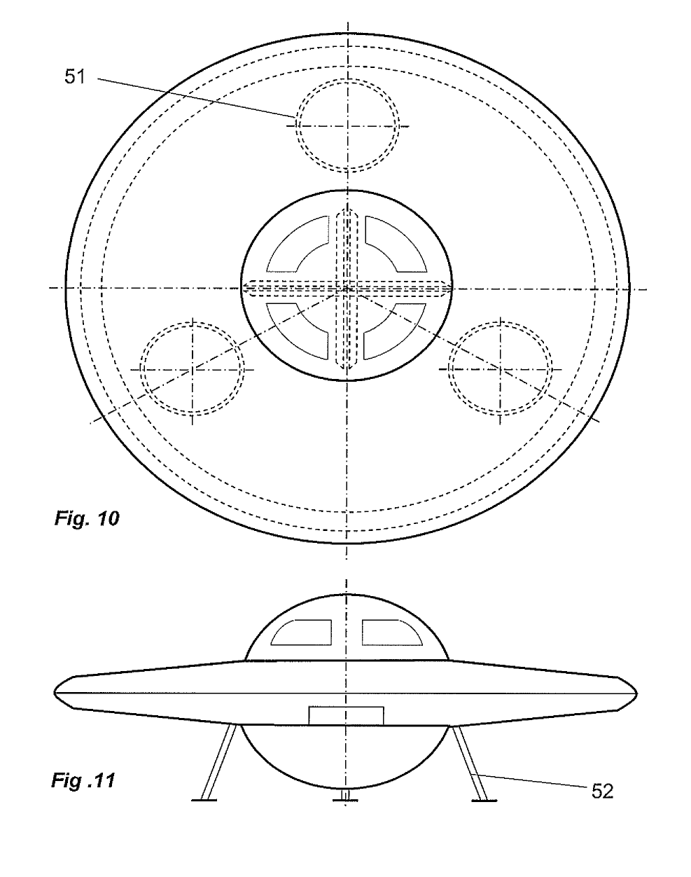

FIGS. 10 and 11 show a further vehicle embodiment having the same overall shape and same arrangement of six CEUs as the embodiment of FIGS. 9 and 7, but differing in the presence of six additional smaller CEUs arranged in three CEU pairs 51 oriented parallel to the outer CEU pairs between the outer CEU pairs and the middle and inner CEU pairs at the center thereof. The six additional CEUs are equal in size to one another and smaller than the other CEUs, and the three CEU pairs 51 they form are equally spaced about the rotational and displacement axis of the outer CEUs (i.e. the Y-axis of FIGS. 6 to 9). Three support legs 52 project downward from the rest of the vehicle at equally spaced apart positions around the same axis to stand the disc-like outer shell 33 enclosing the outer and additional CEUs and the sphere-like central shell 34 enclosing the middle and inner CEUs at the open center of the outer shell 33 above the ground when the vehicle is parked or stored. The vehicle is intended to be maintained in an upright orientation at all times, with the side of the disc-shaped shell 33 on which the legs or other landing gear are disposed being kept as the downward facing side of the vehicle. The three additional CEU pairs are operated as stabilizers, providing vertical lift at radial distances outward from axis of the outer CEUs as required in order to maintain the outer CEU in a substantially horizontal orientation during operation. Arranging the additional CEUs in opposing pairs means that each stabilizer is able to create opposite forces to provide proper stabilization of the vehicle in very turbulent/turmoil condition.)

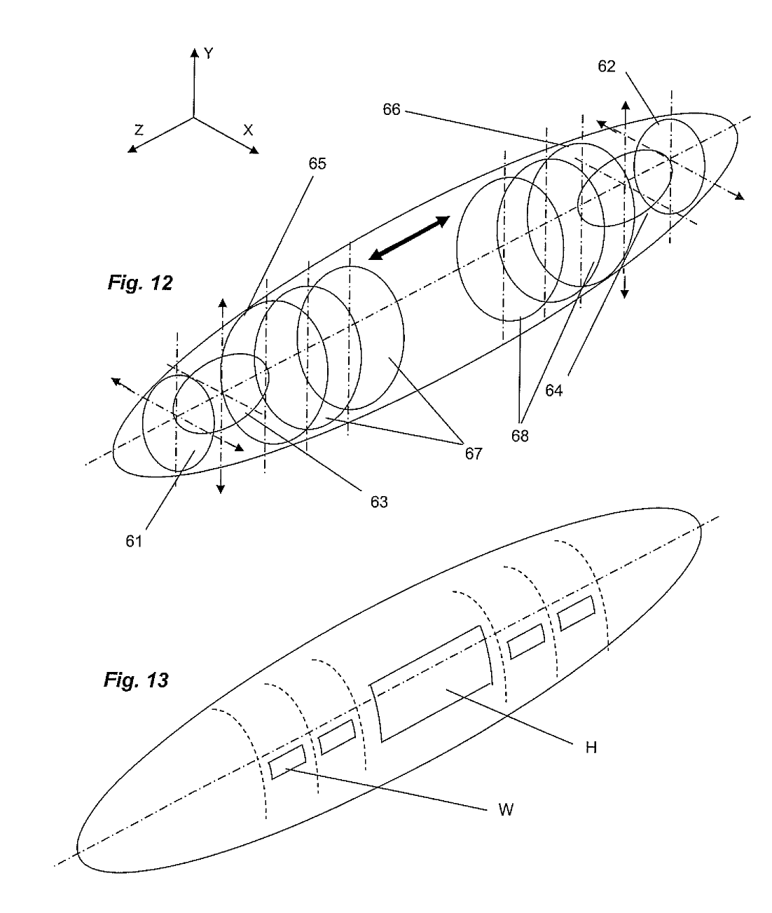

FIGS. 12 and 13 schematically shows a different vehicle embodiment that departs from the circular, disc or saucer-like shape of the embodiments described above, instead taking on a cigar-like shape elongated in one direction, much like the shape conventionally used for airships. The horizontal cigar-axis (parallel to the Z-axis as labeled in the figure) extending in this elongated dimension of the vehicle has all of the vehicle's CEUs positioned thereon at spaced locations therealong. The CEUs are all carried on or with an elongated framework structure, with the engine housings possibly forming parts of this frame, and a cigar-shaped shell may enclose the CEUs within itself and define the overall general shape of the vehicle, as shown in FIG. 13.

With reference to FIG. 12, adjacent each of the opposing ends of the elongated vehicle is a respective CEU pair 61, 62 operable to produce drive forces in opposing directions parallel to a horizontal X-axis perpendicular to the horizontal Z-axis. Moving inward toward the longitudinal center of the vehicle from each end, there is next another CEU pair 63, 64 operable to produce drive forces in opposing directions parallel to the vertical Y-axis perpendicular to the horizontal Z-axis. Next in the same direction from each end is a respective CEU pair 65, 66 operable to produce drive forces in opposing directions along the horizontal cigar axis (i.e. along the length of the vehicle). Next in the same direction from each end are two parallel CEUs 67, 68 operable to produce drive forces in the same direction along the horizontal cigar axis. Accordingly, adjacent the front end of the vehicle corresponding to the positive Z-direction in the figure and in order from this front end toward the center of the vehicle, are an X-direction CEU pair 61, a Y-direction CEU pair 63, a Z-direction CEU pair 65 and two positive Z-direction CEU's 67 operable in the forward direction. Adjacent the opposite rear end of the vehicle in order from this rear end toward the center of the vehicle, are an X-direction CEU pair 62, a Y-direction CEU pair 64, a Z-direction CEU pair 66 and two positive Z-direction CEU's 68 operable in the forward direction.

Position outward from the vehicle's center of mass at a central point along its cigar-axis defining the length dimension of the vehicle, the X-direction CEU pairs 61, 62 can be operated together in a common direction to laterally displace the vehicle or operated at different rotational directions or speeds to control yaw of the vehicle about a vertical axis through its center of mass, the Y-direction CEU pairs 63, 63 can be operated together in a common direction to vertically displace the vehicle or operated at different rotational directions or speeds to control pitch of the vehicle about a horizontal axis through its center of mass parallel to the X axis. The Z-direction CEU pairs 65, 66 and operable to longitudinally displace the vehicle in either direction, and when operated to displace the vehicle in the positive Z-direction, can be augmented by operation of the positive Z-direction CEUs 67, 68 to achieve greater acceleration and velocity of the vehicle.

Each of the vehicles illustrated herein includes space for pilots and vehicle controls, cargo, passengers, batteries or other energy supply units, and other equipment. For example, the vehicles of FIGS. 6 to 11 provide such space within the central opening of the innermost CEUs closing around the center of the vehicle. The vehicle of FIGS. 12 and 13 leaves space between the innermost CEU's along the vehicle's longitudinal axis to form a cargo area accessible by way of a cargo hatch H in the outer shell of the vehicle, while the spacing within the open centers of the vertically oriented CEU's adjacent this middle portion of vehicle accommodates passengers and the spacing between the adjacent CEU pairs allows for windows W installed in the outer shell of the vehicle. It will be appreciated that regardless of the overall vehicle shape and structure applied, the vehicle design uses sizing and spacing of CEU rings to provide enough room for at least a pilot and possibly passengers and/or cargo.

It will be appreciated that the number of CE's used in a vehicle may be varied from those illustrated herein. For example, a track guided vehicle may be produced that only requires a single CEU to provide a single-direction drive force to displace the vehicle along a predetermined laid-out track or rail system, with a CEU pair being employable to add the ability to reverse direction along the track. Although a two-engine CEU structure with counter-rotating rings is preferred, other ways of counteracting a vehicle-spin tendency produced by rotation of one ring may be employed, for example to produce a thrust force at a distance from the ring-axis to cause a moment in a direction about the axis counteracting this spin tendency.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A centrifugal engine comprising:
a round enclosure centered on an axis and defining a sealed interior space within the enclosure, the enclosure comprising an outer wall that closes the interior space around the axis between a base and a cover, an inner surface of the outer wall facing inward toward the axis being nonparallel therewith and sloping outwardly away from the axis where the outer wall extends away from the base toward the cover;
a liquid contained within the sealed interior space; and
a drive system carried with the enclosure and operable to effect rotation of the round enclosure about the axis at sufficient speed to force the liquid outwardly away from the axis against the sloping inner surface of the outer wall and exert pressure against the cover under tendency of the liquid to move theretoward along the sloping inner surface of the outer wall to displace the enclosure and the drive system carried therewith in a direction along the axis corresponding to the pressure against the cover.

2. The centrifugal engine according to claim 1 wherein the enclosure is of a ring structure closing around the axis to enclose an endless channel around the axis between the cover and the base and between the outer wall and an opposing inner wall.

3. The centrifugal engine according to claim 2 wherein the endless channel enclosed by the enclosure and containing the liquid has a rhombus-shaped cross-section.

4. The centrifugal engine according to claim 1 wherein the inner surface of the outer wall slopes between the base and the cover at forty-five degrees relative to the axis in a cross-sectional plane radial thereto.

5. The centrifugal engine according to claim 2 comprising an outer housing in which the ring structure is disposed for rotation about the axis, wherein the drive system comprises electrically conductive coils disposed within the housing with the ring structure passing through the coils and the coils overlapping one another around the axis.

6. The centrifugal engine according to claim 5 wherein the ring structure comprises magnetically attractable sections alternating around the axis with less magnetically attractable sections, the overlapping coils being equal in number to a total number of the magnetically attractable and less magnetically attractable sections and being arranged to energize a first set of alternating coils around the axis to magnetically draw the magnetically attractable sections toward positions centered along paths through the first set of alternating coils, de-energize the first set of alternating coils before the magnetically attractable sections pass said positions and then energize a second set of alternating coils to drive rotation of the ring structure about the axis in a predetermined direction.

7. The centrifugal engine according to claim 5 wherein the endless channel of the ring structure is divided into sections positioned end-to-end around the axis, alternating sections around the axis containing opposite ones of a magnetically attractable liquid and a less magnetically attractable liquid, the overlapping coils being equal in number to a total number of the sections and being arranged to energize a first set of coils alternating around the axis to magnetically draw the sections containing the magnetically attractable liquid toward positions centered along paths through the first set of coils and de-energize before the same sections pass said positions to drive rotation of the ring structure about the axis in a predetermined direction.

8. The centrifugal engine according to claim 5 wherein the ring structure rotates within the housing along interfaces between outer surfaces of the ring structure and inner surfaces of the outer housing, the coil closing about the ring outward from the sliding interfaces.

9. The centrifugal engine according to claim 8 wherein the interfaces comprise sliding interfaces where the outer surfaces of the ring structure slide over the inner surfaces of the outer housing.

10. The centrifugal engine according to claim 9 comprising friction reducing material at the sliding interfaces.

11. The centrifugal engine according to claim 10 wherein the friction reducing material comprises Teflon.

12. The centrifugal engine according to claim 1 wherein the liquid comprises non-compressible heavy liquid.

13. The centrifugal engine according to claim 12 wherein the liquid is mercury.

14. According to a second aspect of the invention there is provided a vehicle comprising:
a frame;
a centrifugal engine set comprising at least one centrifugal engine unit carried on the frame, each centrifugal engine unit comprising at least one centrifugal engine and each centrifugal engine comprising:
a round enclosure centered on a respective axis and defining a sealed interior space within the enclosure, the enclosure comprising an outer wall that closes the interior space around the axis between a base and a cover, an inner surface of the outer wall facing inward toward the axis being nonparallel therewith and sloping outwardly away from the axis where the outer wall extends away from the base toward the cover;
a liquid contained within the sealed interior space; and
a drive arrangement carried on the frame with the enclosure and operable to effect rotation of the enclosure about the axis at sufficient speed to force the liquid outwardly away from the axis against the sloping inner surface of the outer wall and exert pressure against the cover under tendency of the liquid to move theretoward along the sloping inner surface of the outer wall to displace the enclosure, the drive system and the frame in a direction along the axis corresponding to the pressure against the cover.

15. The vehicle according to claim 14 wherein the centrifugal engine unit set comprises two centrifugal engine units having their axes oriented perpendicular to one another to effect displacement in perpendicular directions along a plane in which the axes lie.

16. The vehicle according to claim 14 wherein the centrifugal engine unit set comprises three centrifugal engine units having their axes oriented perpendicular to one another to facilitate motion of the vehicle in three dimensions.

17. The vehicle according to claim 14 wherein each centrifugal engine unit comprises a pair of engines, each pair of engines comprising two engines lying on a common axis, facing a common direction therealong to exert the pressure of the fluids in the common direction and rotating the fluids in the two engines in opposite directions about the common axis to counteract tendencies of one another to spin the frame about the common axis.

18. The vehicle according to claim 17 wherein the centrifugal engine unit set comprises six centrifugal engine units arranged in three pairs, each pair consisting of two centrifugal engine units that lie on a common axis perpendicular to the axes of the other two pairs and face opposite directions along the common axis to exert the pressure of the fluids of the two centrifugal engine units in the opposite directions, whereby the three pairs of centrifugal engine units are operable to effect displacement of the vehicle in three perpendicular directions.

19. The vehicle according to claim 14 wherein the centrifugal engine unit set comprises at least one opposing pair of centrifugal engine units, each opposing pair of centrifugal engine units comprising two centrifugal engine units lying on coincident axes and facing opposite directions therealong each to effect displacement of the vehicle in the opposite directions along the coincident axes under separate operation of the two centrifugal engines

20. The vehicle according to claim 17 wherein the centrifugal engine unit set comprises a plurality of centrifugal engine units disposed at spaced apart positions along one of the axes thereof, the one of the axes also defining an axis of an elongated structure of the frame on which the plurality of centrifugal engine units are carried, and the plurality of centrifugal engines comprising, at each end of the elongated structure, two centrifugal engine units having the axes thereof oriented perpendicular to one another and to the axis of an additional third centrifugal engine lying on the axis of the elongated structure.

21. The vehicle according to claim 16 wherein the enclosure of each engine is a ring structure and the axes of the three centrifugal engine units intersect at a common central point of the vehicle, the ring structure of each engine of an outer engine unit of the three pair of centrifugal engine units closing around the ring structures of two center engine units of the three centrifugal engine units and the ring structure of each engine of one of the two center engine units closing about the other center engine unit.

22. The vehicle according to claim 21 wherein the ring structure of each engine of the outer engine unit closes around additional centrifugal engine units spaced apart about the axis of the outer engine unit in orientations parallel thereto for use as stabilizers.

23. The vehicle according to claim 16 wherein the three centrifugal engines are disposed at spaced apart positions along one of the axes thereof.

24. The centrifugal engine according to claim 6 wherein the endless channel of the ring structure is divided into independent segments positioned end-to-end around the axis and each filled with the liquid, each independent segment of the endless channel corresponding to a respective one of the magnetically attractable and less magnetically attractable segments and the liquid comprising a non compressible heavy liquid.
